(19) United States
(12) Patent Application Publication
(10) Pub. No.: US 2010/0275859 A1
(43) Pub. Date: Nov. 4, 2010

(54) METHOD TO PROVIDE SUPPLEMENTAL FUEL FOR AN INTERNAL COMBUSTION ENGINE

(75) Inventor: Mark N. Klotz, Lanesville, IN (US)

Correspondence Address: MICHAEL RIES, 318 PARKER PLACE, OSWEGO, IL, 60543, US

(73) Assignee: Alternative Power Technologies, LLC, Sun Prairie, WI (US)

(21) Appl. No.: 12/607,062

(22) Filed: Oct. 28, 2009

Related U.S. Application Data
(60) Provisional application No. 61/112,722, filed on Nov. 8, 2008.

(51) Int. Cl. F02B 43/08; C25B 15/08; C25B 9/00; B65D 30/10

(52) U.S. Cl. 123/3; 204/241; 204/267; 220/9.1

(57) ABSTRACT

The present invention is directed to a method and system for supplementing fuel for an internal combustion engine by applying a current across a cathode and an anode in an aqueous electrolyte solution to generate fuel gas such as hydrogen; directing the fuel gas to fill a collapsible bag; directing the fuel gas past the collapsible bag to the internal combustion engine when the collapsible bag is full; and allowing the fuel gas that filled the collapsible bag to be drawn into the engine when the engine requires a fuel boost.

### REFERENCE TO RELATED APPLICATIONS

This patent application claims the benefit of U.S. Provisional Application No. 61/112,722 filed on 8 Nov. 2008, the disclosure of which is incorporated herein in its entirety by reference.

### BACKGROUND OF THE INVENTION

1. Field of the Invention

The present invention relates to apparatus, method and system for generating supplemental fuel for an internal combustion engine.

2. Description of Related Art

As anyone can see with our economy the reserves of petroleum seem to be fading away and, at the same time, the need for petroleum around the world seems to be more in demand. Because of this, fuel prices, both gasoline and diesel have demanded that people invent alternative ways to fuel cars, trucks, buses, planes, etc. to allow our economy to offer more efficient and economical means of fueling. This endeavor has sparked much interest for inventions all over the world. An example of this would be a means of using water to form combustible gasses to use with petroleum fuel to create internal combustion. This invention is the generation of combustible gasses such as hydrogen obtained from water to supplement petroleum fuels for an internal combustion engine. Electricity which can be generated by the engine can be used to electrolyze water to capture some of the energy lost to the inefficiencies of the internal combustion engine.

The idea of using water as a supplement fuel is not a new idea as shown by,

U.S. Pat. No. 7,240,641 to Balan et al.

U.S. Pat. No. 7,021,249 to Christison;

U.S. Pub. No. 2005/0,217,991 Al to Dahlquist, Jr.

U.S. Pat. No. 6,332,434 to De Souza et al.

U.S. Pat. No. 6,311,648 to Lorocque;

U.S. Pat. No. 6,257,175 to Mosher et al.

U.S. Pat. No. 5,450,822 to Cunningham;

U.S. Pat. No. 5,305,715 Nissly;

U.S. Pat. No. 7,100,542 to Ehresman et al.

U.S. Pat. No. 5,231,954 to Stowe;

U.S. Pat. No. 5,178,118 to Nakamats;

U.S. Pat. No. 4,442,801 to Glynn et al.

U.S. Pat. No. 4,271,793 to Valdespino.

Because petroleum reserves are shrinking and fuel costs are rising everywhere, people are searching for simple and easy to fuel automobiles.

### SUMMARY OF THE INVENTION

The present invention is directed to a method for supplementing fuel for an internal combustion engine by applying a current across a cathode and an anode in an aqueous electrolyte solution to generate fuel gas; filling a collapsible bag with fuel gas when the collapsible bag is not substantially full; allowing the fuel gas to bypass the collapsible bag towards the internal combustion engine when the collapsible bag is full; and drawing fuel gas from the collapsible bag into the engine when the engine requires a fuel boost.

The present invention is also directed to a system for providing fuel gas for an internal combustion engine comprising a tank containing an aqueous electrolytic solution; an electrolytic tank containing a cathode and an anode; a pump that circulates aqueous electrolyte solution from the tank into a cooler comprising a fan and a radiator and back to the tank; a spout that directs fuel gas to a collapsible bag that is connected to a turbo intake of the internal combustion engine.

The present invention is also directed to an electrolytic tank comprising a spaced apart electrode array of a cathode and an anode, wherein the spaced-apart electrode array is secured by a positive bolt that passes through a positive bolt duct on each electrode and a negative bolt that passes through a negative bolt duct on each electrode, and wherein the negative bolt is isolated electrically from the cathode by a first rubber grommet and the positive bolt is isolated electrically from the anode by a second rubber grommet.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a diagram of an embodiment of a gas generator in accordance with the principles of the invention;

FIG. 2 is a cross sectional view of an embodiment of an electrolytic tank in accordance with the principles of the invention;

FIG. 3 is illustrates an embodiment of an electrode plate in accordance with the principles of the invention;

FIG. 4 illustrates a notched neutral plate;

FIG. 5 is a cross sectional view of a collapsible bag in accordance with the principles of the invention;

FIG. 6 is an embodiment of an electrical diagram that shows the circuitry used in an embodiment of the present invention; and

FIG. 7 is a perspective view of the invention.

### DETAILED DESCRIPTION OF THE INVENTION

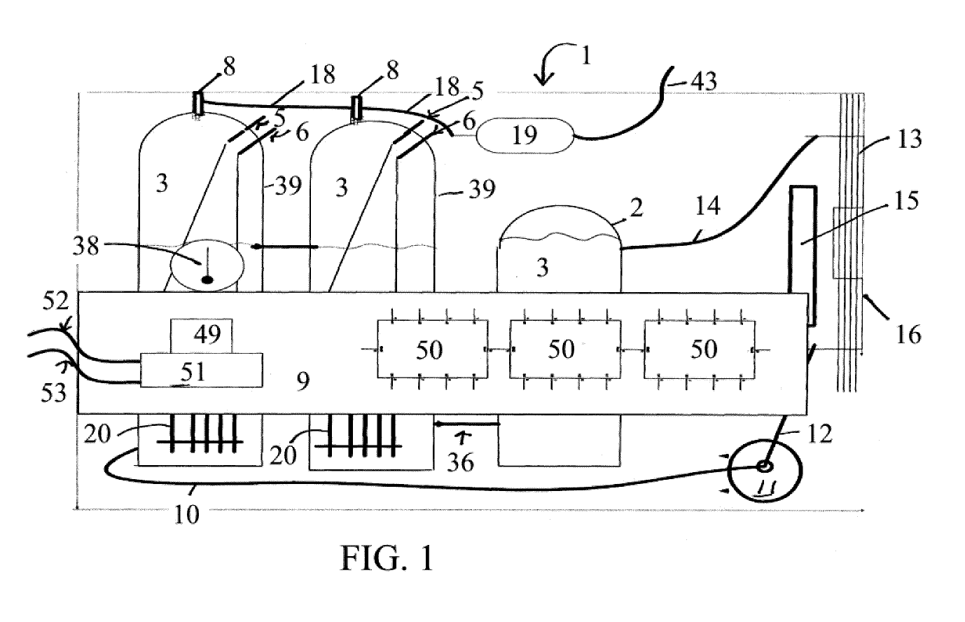

FIG. 1 is a diagram of an embodiment of a gas generator 1 in accordance with the principles of the invention. Gas generator 1 contains holding tank 2 that contains an aqueous electrolyte solution 3. Holding tank 2 is used to cool the electrolytic in tanks 39 which include electrodes that are submerged in an aqueous electrolyte solution 3. Fuel gas is generated with a current delivered to electrodes in the electrolytic tanks 39 through electrode connectors 5 and 6, where water from the solution is split into hydrogen and oxygen. As fuel gas, hydrogen and oxygen, accumulates, it drifts to gas spouts 8 where it is directed through tubing 18 past gas drier 19 towards an internal combustion engine 43.

Additional components of gas generator 1 include electrical panel 9, tubing 10 that connects electrolytic tank 39 to pump 11, tubing 12 that connects pump 11 to radiator 13 which is connected by tubing 14 to holding tank 2. Radiator 13 and fan 15 together form cooling component 16. As one can imagine, the gas generator may not operate if the temperature is below freezing. Accordingly, the circuit boards 50 are designed to prevent the electrolytic tanks 39 from operating until the tank and the tubes are warmed so that the electrolyte solution is liquid. Once the solution is liquid, circuit board 50 supplies current which flows to electrode connectors 5 and 6 to begin the electrolytic process to generate the fuel gas. Circuit board 50 controls the source power to heater fan 49, heater core 51, vehicle radiator fluid in hose 52, vehicle radiator fluid out hose 53, as well as fan 15, pump 11, electrolytic tank 39 and temperature sensor 38. Heater operation is by hot radiator fluid in hose 52 entering heater core 51, warming heater core to a temperature of between 108 and 210 degrees F., at which time heater fan 49 warms all components of gas generator 1. Fluid continues to circulate back to vehicle radiator fluid out hose 53 and to the vehicle system.

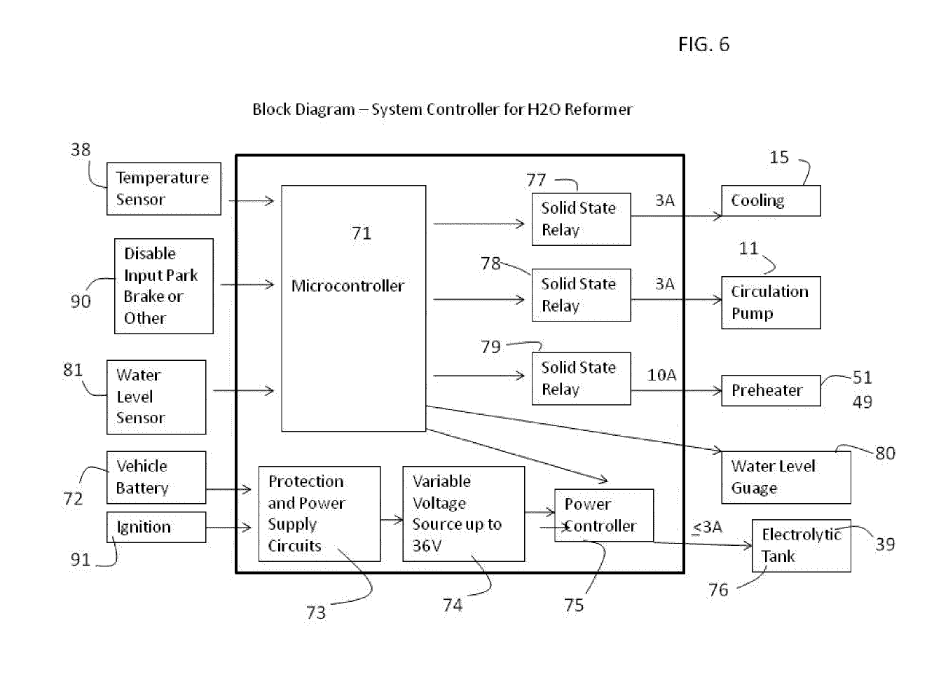

Referring to FIG. 6, there is shown a Block Diagram-System Controller for H20 Reformer 70. The best way to describe System Controller Reformer 70 is to trace the steps performed by the controller starting with vehicle power source 72 and ending with microcontroller 71. Initially, vehicle ignition 91 is provided, power supply 72 activates protection and power supply circuitry 73. Variable voltage source 74 is engaged and voltage of up to 36V is fed to power controller 75. Microcontroller 71, which is connected to temperature sensor 38, activates power controller 75 which feeds power to Electrolytic tank 39 (FIG. 1). If temperature sensor 38 sends a signal to microcontroller 71 that the temperature is below 32 degrees F., solid state relay 79 will operate pre-heater 51 and 49 which can use up to 10 amps at 12 volts. Once microcontroller 71 receives information from thermostat sensor 38 that the temperature is above freezing, 32 degrees F., microcontroller 71 sends a signal to relay 79 for pre-heaters 51 and 49 to turn off and sends a signal to relay 78 to turn on circulation pump 11, and relay 77 to turn on cooling fan 15. Microcontroller 71 also receives information from water level sensor 81 which is in holding tank 2 to water level gauge 80 located in the dashboard of a vehicle. Lastly. microcontroller receives an input signal from the vehicle parking brake sensor 90 which will shut down the entire system should the parking brake be engaged.

During operation of the gas generator, the electrolyte solution is cooled to minimize dew point. For example, when the ambient temperature is below freezing, the electrolyte solution is warmed to only one or two degrees above freezing. When the ambient temperature is relatively high, the solution temperature is cooled below the dew point. For example, the operable temperature when ambient temperature is freezing or just above freezing is about 33-36 degrees F. In warmer temperature, the solution is operable at about 69-73 degrees F.

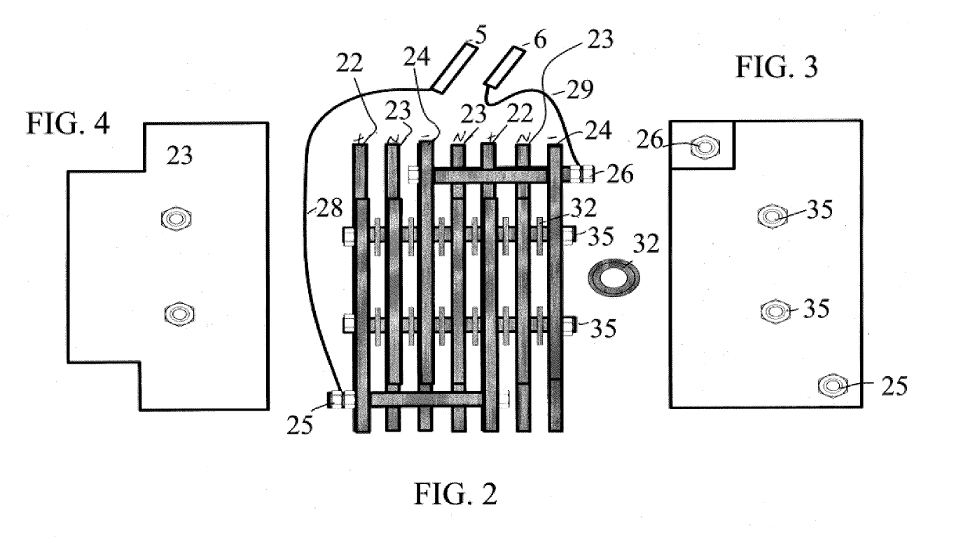

FIGS. 2 and 3 provide greater details of the electrolytic tank 39. Electrolytic tank 39 includes an electrode array 20 that has two cathode plates 22, two neutral plates 23, and two anode plates 24. A variety of arrays are contemplated, with the simplest being one cathode plate and one anode plate. The plates can be made from stainless steel and may degrade during the electrolytic process. After a certain amount of use, the electrolytic plates and/or tank can be replaced.

The electrode array shown is particularly stable because each electrode is secured by at least two conducting bolts 25 and 26 and corresponding nuts with the spaced-apart relationship created by rubber grommets 32 that separate the electrodes from each other. As shown, conducting bolt 25 is the positive bolt, while conducting bolt 26 is the negative bolt. However, the polarity of the bolts can be reversed. In the present embodiment, bolt 25 is connected by conductor 28 to electrode connector 5, while bolt 26 is connected by conductor 29 to electrode connector 6. As shown, the polarity of the electrode connectors is positive at 5 and negative at 6.

In an embodiment, an electrode plate has two ducts 26 and 25 for the conducting bolts. The plate shown can be a cathode or an anode depending on the electrical connection that is created with the conducting bolts. In the case of a neutral plate 23, (FIG. 4) the plate itself is notched so as not to touch either the anode or the cathode duct.

Additional stability features are obtained by including two additional structural ducts 35 and 35 which pass through the array of plates 20 for receiving plastic or fiberglass nuts and bolts. Both ducts are insulated by rubber grommets 32. The rubber grommets 32 provide sufficient thickness to separate and insulate the plate from the bolts, and also have sufficient thickness to separate adjacent plates in the array.

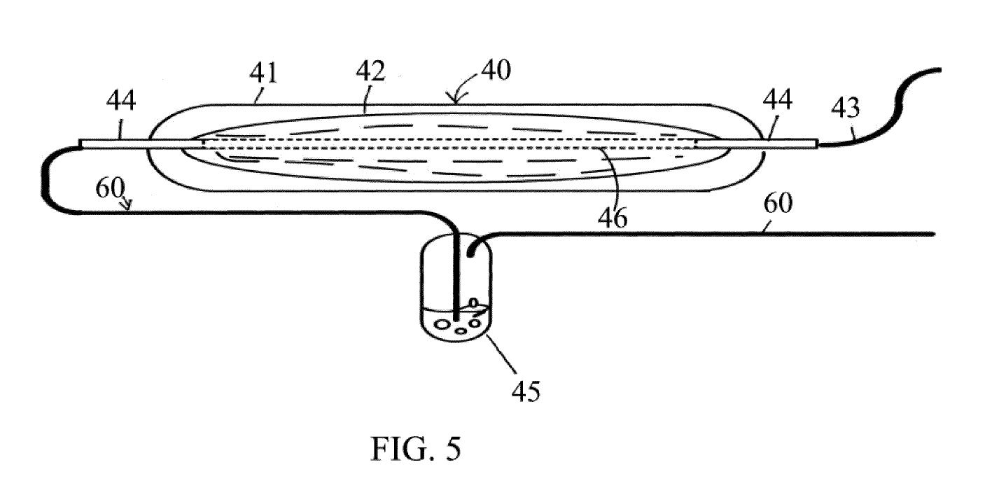

Although fuel gas from the generator may be steadily generated and consumed when supplied directly to the engine, in an embodiment, a collapsible bag is used to store gas and provide a boost of fuel gas when the engine requires additional power. FIG. 5 illustrates a collapsible bag assemblage 40 having a rigid shell 41 that contains a collapsible bag 42. The shell is made from any rigid material known in the art such as PVC steel, etc., while the bag can be made from any number of flexible materials known in the art such as rubber or plastic such as a vinyl. Tubing 43 carries the fuel gas from the gas generator to the bag where it is attached to rigid tubing 44 that passes through both the rigid shell and the collapsible bag. When the rigid tubing has passed through the collapsible bag, it is attached to flexible tubing 60 which caries the fuel gas towards the engine. In the embodiment shown, a bubbler 45 is added to regulate the flow of fuel gas. The section of rigid tubing 44 that is located in region 46 has multiple fine pin holes to allow a portion of the fuel gas to collect in the flexible bag 42, while another portion of the fuel gas continues to the engine.

In operation, the bag serves as a fuel gas reservoir. While the consumption of fuel by an internal combustion engine is ideally steady, the consumption is, in reality, variable. When a vehicle is moving up an incline or is moving into a headwind, the engine requires more fuel. Without the bag, the gas generator supplies a steady flow of fuel gas to the engine regardless of the consumption needs of the engine at any particular time. With the bag, fuel gas is still steadily supplied when the engine does not require additional power. However, when the engine requires more fuel, a vacuum is created that taps into the fuel gas that is stored in the bag. When the additional fuel is no longer needed, a portion of the fuel gas is diverted to fill the bag while another portion is supplied to the engine. On some occasions the additional fuel consumption may completely deplete the reserves in the bag, in which case, only the flow generated will be available until consumption is reduced to the point that gas can be diverted to refill the bag.

Numerous electrolyte solutions can be used with this invention. In an embodiment, the aqueous electrolyte solution 3 is about six gallons of water with about six ounces of baking soda in the system, about five gallons in holding tank 2 and one gallon circulating outside of the holding tank, primarily in the radiators. In another embodiment, the amount of baking soda used can be greater than or equal to about four ounces with about six gallons of water. In yet another embodiment, sea water can be used in place of the baking soda solution.

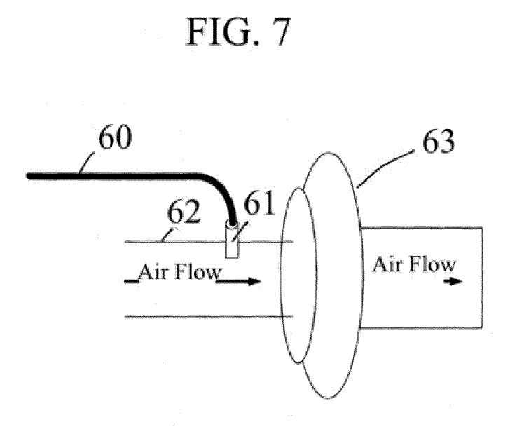

FIG. 7 is a perspective view of the various component of an embodiment of the supplemental fuel system according to the principles of the invention, from gas generator 1 to the intake of the engine. In one embodiment, the intake is the turbo intake of the engine. The gas generated is about 6 liters per minute. The amount of fuel saved is about 50% while the horsepower is improved by 22.5%. The pressure increases before the turbo intake is up to about 2 pounds per square inch. Flexible tubing 60 which is securely joined to air fitting 61 allows gasses to travel into turbo inlet 62. When gasses enter turbo 63, they are pressurized from 5 to 45 pounds of pressure before being fed to the internal combustion engine manifold and thus to the cylinders for ignition.

While the present invention has been described in considerable detail, it will be obvious to those skilled in the art that alternations may be made in the described system, device or method without departing from the concept and scope of the present invention as described in the claims that are set forth herein.

What is claimed is:

1. A method for providing fuel gas for an internal combustion engine comprising:
using electrolysis to generate a fuel gas such as hydrogen from water;
filling a collapsible bag with said fuel gas when the collapsible bag is not substantially full;
allowing the fuel gas to bypass the collapsible bag and move towards the internal combustion engine when the collapsible bag is substantially full; and
drawing fuel gas from the collapsible bag into the engine when the engine requires a fuel boost.

2. The method of claim 1, wherein the collapsible bag has a rigid shell that contains a collapsible bag, a rigid tube passes through both the rigid shell and the collapsible bag, and a portion of the rigid tube that is enclosed in the collapsible bag has pinholes to allow fuel gas to collect in the collapsible bag.

3. The method of claim 2 wherein a portion of fuel gas is directed to the collapsible bag, and another portion of fuel gas is directed towards the internal combustion engine.

4. A system for providing fuel gas for an internal combustion engine comprising:
a tank containing an aqueous electrolyte solution;
an electrolytic tank;
a pump that circulates aqueous electrolyte solution from the tank into a cooler having a fan and a radiator and back to the tank;
wherein the electrolytic tank comprises a spaced apart electrode array that is partially immersed in the electrolyte solution, the electrode array having a cathode and an anode, and the spaced-apart electrode array is secured by a positive bolt that passes through a positive bolt duct on each electrode and a negative bolt that passes through a negative bolt duct on each electrode, and the negative bolt is isolated electrically from the cathode by a notch in a neutral plate and the positive bolt is isolated electrically from the anode by a notch in the neutral plate.

5. The system of claim 4, further comprising a collapsible bag that is connected on one end to the tank by a gas spout, and on an opposing end to the internal combustion engine.

6. The system of claim 5, wherein the collapsible bag is connected to the internal combustion engine at a turbo intake.

7. A system for providing fuel gas for an internal combustion engine comprising:
a tank containing an aqueous electrolyte solution;
a electrolytic tank having an electrode array that is partially immersed in the aqueous electrolyte solution;
a pump capable of circulating aqueous electrolyte solution from the tank to a cooler having a fan and a radiator and back to the tank; and
a collapsible bag connected on one end to the tank by a gas spout, and on an opposing end to the internal combustion engine.

8. The system of claim 7, wherein the collapsible bag is connected to the internal combustion engine at a turbo intake.

9. An electrolytic tank comprising:
a spaced-apart electrode array of a cathode plate and an anode plate, wherein the spaced-apart electrode array is secured by a positive bolt that passes through a positive bolt duct on each electrode and a negative bolt that passes through a negative bolt duct on each plate, and wherein the negative bolt is isolated electrically from the cathode plate by a plate having a notch and the positive bolt is isolated electrically from the anode plate by a second notch in the plate;
wherein the cathode plates are charged through a variable voltage source that can vary from 12 volts to 36 volts depending upon a system availability of excess power not draining a vehicle's charging system.

10. The electrolytic tank of claim 9 wherein the notches are in a neutral plate.

11. The electrolytic tank of claim 10, wherein the electrode array comprised two cathode plates, two anode plate, and two neutral plates arranged as cathode plate, neutral plate, anode plate, neutral plate, and cathode plate, neutral plate, anode plate.

12. The electrolytic cell of claim 9, wherein each plate further comprises a structural duct protected by a non-conducting cover through which a non-conducting bolt is inserted through each plate and secured with a non-conducting nut to provide further structural integrity.
